(19) United States
(12) Patent Application Publication
(10) Pub. No.: US 2014/0286434 A1
(43) Pub. Date: Sep. 25, 2014

(54) IMAGE-ENCODING METHOD AND IMAGE-DECODING METHOD

(71) Applicant: ELECTRONICS AND TELECOMMUNICATIONS RESEARCH INSTITUTE, Daejeon (KR)

(72) Inventors: Ha Hyun Lee, Seoul (KR); Jung Won Kang, Daejeon (KR); Jin Soo Choi, Daejeon (KR); Jin Woong Kim, Daejeon (KR)

(21) Appl. No.: 14/350,267

(22) PCT Filed: Oct. 5, 2012
(86) PCT No.: PCT/KR2012/008098

§ 371 Date: Apr. 7, 2014

(30) Foreign Application Priority Data
Oct. 5, 2011 (KR) 10-2011-0101141
Sep. 10, 2012 (KR) 10-2012-0099969
Oct. 5, 2012 (KR) 10-2012-0110573

(51) Int. Cl. H04N 19/33; H04N 19/80; H04N 19/187

(52) U.S. Cl. CPC H04N 19/00436; H04N 19/00321; H04N 19/0089
USPC 375/240.16

(57) ABSTRACT

The present invention relates to an image-encoding method, to an image-decoding method, and to an apparatus using same. The image-encoding method according to the present invention comprises the following steps: determining the location of a corresponding sample in a reference layer; restoring a sample of a reference unit in the reference layer, specified by the corresponding sample, so as to generate a reference sample signal; and encoding a differential signal between the sample signal of the current unit of an enhancement layer and the reference sample signal.

### CROSS-REFERENCE TO RELATED APPLICATIONS

This application claims the benefit of priority of Korean Patent Application No. 10-2011-0101141 filed on Oct. 5, 2011, Korean Patent Application No. 10-2012-0099969 filed on Sep. 10, 2012, and Korean Patent Application No. 10-2012-0110573 filed on Oct. 5, 2012, all of which is incorporated by reference in its entirety herein.

### BACKGROUND OF THE INVENTION

1. Field of the Invention

The present invention relates to a method of encoding and decoding an image and, more particularly, to a method of inter layer texture prediction for scalable video coding (SVC) and an apparatus using the same.

2. Related Art

As a multimedia environment is established, various user equipments (UE) and networks are used so that the demands of users are diversified.

For example, as performances and computing abilities of the UEs are diversified, performances supported by the UEs are diversified. In addition, functions of the networks determined by types, amounts, and speeds of information items transmitted to the networks as well as external structures of the networks to which the information items are transmitted are diversified. The users select the UEs and networks to be used in accordance with desired functions and spectrums of the UEs and networks provided by enterprises to the users are diversified.

In relation to the above, recently, as broadcasting having high definition (HD) resolution is globally as well as domestically served, many users are accustomed to high resolution and high picture quality images. Therefore, many image service related organs are accelerating development of next generation imaging devices.

In addition, as interest in ultra high definition (UHD) having resolution of no less than four times HDTV as well as HDTV increases, demands on a technology of compressing and processing an image of higher resolution and picture quality are increasing.

In order to compress and process the image, an inter prediction technology of predicting a pixel value included in current picture from prior and/or posterior picture, an intra prediction technology of predicting other pixel values included in the current picture using information on the pixel in the current picture, and an entropy encoding technology of allotting a short code to a symbol having a high frequency of occurrence and of allotting a long code to a symbol having a low frequency of occurrence may be used.

As described above, when the UEs and networks that support different functions and the diversified demands of the users are considered, the quality, size, and frame of a supported image need to be diversified.

Due to the different kinds of communication networks and the UEs of various functions/kinds, scalability of variously supporting the picture quality, resolution, size, and frame rate of the image becomes an important function of a video format.

Therefore, in order to provide services requested by the users in various environments based on a highly efficient video encoding method, it is necessary to provide a scalability function so that efficient video encoding and decoding may be performed in terms of time, space, and picture quality.

### SUMMARY OF THE INVENTION

An aspect of the present invention provides a method of differently selecting the locations of reconstructed reference sample signals of a reference layer when enhancement layers are encoded/decoded in scalable video coding (SVC) and an apparatus therefor.

Another aspect of the present invention provides a method of predicting an object unit of an enhancement layer using sample signals obtained by applying filtering and/or offset to reconstructed reference sample signals as predicted signals or reconstructed signals in SVC and an apparatus therefor.

Still another aspect of the present invention provides a method of omitting a process of encoding a differential signal or minimizing a differential signal by applying filtering or offset that minimizes an error between reconstructed reference sample signals and an original signal in SVC and an apparatus therefor.

Still another aspect of the present invention provides a method of improving encoding efficiency in SVC and an apparatus therefor.

According to an aspect of the present invention, there is provided a method of encoding an image. The method includes determining a location of a corresponding sample in a reference layer, generating a reference sample signal by reconstructing a sample of a reference unit in a reference layer specified by the corresponding sample, and encoding a differential signal between a sample signal of a current unit of an enhancement layer and the reference sample signal. The corresponding sample is a sample of the reference layer corresponding to a reference sample specifying the current unit.

In determining the location of the corresponding sample, the location of the corresponding sample may be determined by scaling the location of the corresponding sample in accordance with a ratio between a size of an image of the reference layer and a size of an image of the enhancement layer.

At this time, a height component of the location of the corresponding sample may be scaled in accordance with a ratio between a height of the image of the reference layer and a height of the image of the enhancement layer and a width component of the location of the corresponding sample may be scaled in accordance with a ratio between a width of the image of the reference layer and a width of the image of the enhancement layer.

In generating the reference sample signal, a size of the reference unit may be scaled in accordance with a ratio between a size of an image of the reference layer and a size of an image of the enhancement layer.

At this time, a height of the reference unit may be scaled in accordance with a ratio between a height of the image of the reference layer and a height of the image of the enhancement layer and a width of the reference unit may be scaled in accordance with a ratio between a width of the image of the reference layer and a width of the image of the enhancement layer.

In generating the reference sample signal, the reference sample signal may be generated by scaling the reconstructed sample in accordance with a ratio between a size of an image of the reference layer and a size of an image of the enhancement layer.

In generating the reference sample signal, the reference sample signal may be generated by applying filtering after reconstructing a sample of the reference unit.

At this time, a filter coefficient used for the filtering may be a filter coefficient of minimizing the differential signal.

In generating the reference sample signal, the reference sample signal may be generated by applying offset after reconstructing the sample of the reference unit.

At this time, the offset may be offset of minimizing the differential signal.

According to another aspect of the present invention, there is provided a method of decoding an image. The method includes deriving a location of a corresponding sample in a reference layer, generating a reference sample signal by reconstructing a sample of a reference unit in a reference layer specified by the corresponding sample, and reconstructing a sample signal of a current unit in an enhancement layer based on a differential signal received from an encoder and the reference sample signal. The corresponding sample may be a sample of the reference layer corresponding to a reference sample specifying the current unit.

In deriving the location of the corresponding sample, the location of the corresponding sample may be derived by scaling the location of the corresponding sample in accordance with a ratio between a size of an image of the reference layer and a size of an image of the enhancement layer.

At this time, a height component of the location of the corresponding sample may be scaled in accordance with a ratio between a height of the image of the reference layer and a height of the image of the enhancement layer and a width component of the location of the corresponding sample may be scaled in accordance with a ratio between a width of the image of the reference layer and a width of the image of the enhancement layer.

In generating the reference sample signal, a size of the reference unit may be scaled in accordance with a ratio between a size of an image of the reference layer and a size of an image of the enhancement layer.

At this time, a height of the reference unit may be scaled in accordance with a ratio between a height of the image of the reference layer and a height of the image of the enhancement layer and a width of the reference unit may be scaled in accordance with a ratio between a width of the image of the reference layer and a width of the image of the enhancement layer.

In generating the reference sample signal, the reference sample signal may be generated by scaling the reconstructed sample in accordance with a ratio between a size of an image of the reference layer and a size of an image of the enhancement layer.

In generating the reference sample signal, the reference sample signal may be generated by applying filtering after reconstructing a sample of the reference unit.

At this time, the filtering may be performed based on a ratio between a size of an image of the reference layer and a size of an image of the enhancement layer and the filtered reconstructed sample may be scaled in accordance with a ratio between a size of an image of the reference layer and a size of an image of the enhancement layer.

In generating the reference sample signal, the reference sample signal may be generated by applying offset after reconstructing a sample of the reference unit.

At this time, the offset may be applied based on a ratio between a size of an image of the reference layer and a size of an image of the enhancement layer and the reconstructed sample to which the offset is applied may be scaled in accordance with a ratio between a size of an image of the reference layer and a size of an image of the enhancement layer.

According to the present invention, when at least one post-processing technology such as a deblocking filter, sample adaptive offset (SAO), and an adaptive loop filter (ALF) is applied in encoding and decoding processes, locations of obtaining reconstructed reference sample signals of the reference layer may be differently selected so that it is possible to reduce complexity and to improve encoding efficiency.

According to the present invention, filter is applied or offset is added so that an error between a reconstructed reference sample signal and an original sample signal is minimized so that a differential signal may be reduced.

According to the present invention, the filtering is applied or the offset is added so that the error between the reconstructed reference sample signal and the original sample signal is minimized. Therefore, it is possible to omit a process of encoding the differential signal and to improve the encoding efficiency.

### BRIEF DESCRIPTION OF THE DRAWINGS

FIG. 1 is a block diagram illustrating a basic structure of an encoding apparatus according to an embodiment;

FIG. 2 is a block diagram illustrating a basic structure of a decoding apparatus according to an embodiment;

FIG. 3 is a conceptual diagram schematically illustrating an embodiment of a scalable video coding (SVC) using multiple layers according to the present invention;

FIG. 4 is a flowchart schematically illustrating a method of encoding an enhancement layer in the encoding apparatus according to the present invention;

FIG. 5 is a view schematically illustrating an example of a method of determining reference samples of a current unit (a unit to be currently encoded or a unit to be currently decoded) and a method of specifying a unit of a reference layer using the same;

FIG. 6 is a flowchart schematically illustrating an example of a method of applying an in-loop filter; and

FIG. 7 is a flowchart schematically illustrating a method of decoding the enhancement layer in the decoding apparatus according to the present invention.

### DESCRIPTION OF EXEMPLARY EMBODIMENTS

Hereinafter, embodiments of the present invention will be described in detail with reference to drawings. In describing the embodiments of the specification, when it is determined that detailed description of a related published structure or function may blur the subject matter of the specification, detailed description thereof will be omitted.

In the specification, when an element is referred to as being “connected to” or “coupled to” another element, the element may be directly connected to or coupled to another element or intervening elements may exist. Further, in the specification, when it is referred to as “including” a specific structure, it does not mean that structures other than the corresponding structure are excluded but it means that additional structures may be included in performing the present invention or in the spirit and scope of the present invention.

The terms “first and second” may be used for describing various structures. However, the structures are not limited by the terms. The terms are used for distinguishing one element from other elements. For example, a first element may be referred to as a second element without departing from the spirit and scope of the present invention and the second element may be referred to as the first structure.

In addition, the elements according to the embodiments of the present invention are illustrated to be independent from each other in order to represent different functions and it does not mean that the elements are formed of separated hardware or one software module. That is, the elements are listed for convenience sake. At least two elements among the elements may form one element or one element may be divided into a plurality of elements to perform functions. An embodiment in which the elements are integrated with each other and an embodiment in which the elements are separated from each other are included in the scope of the present invention without departing from the spirit of the present invention.

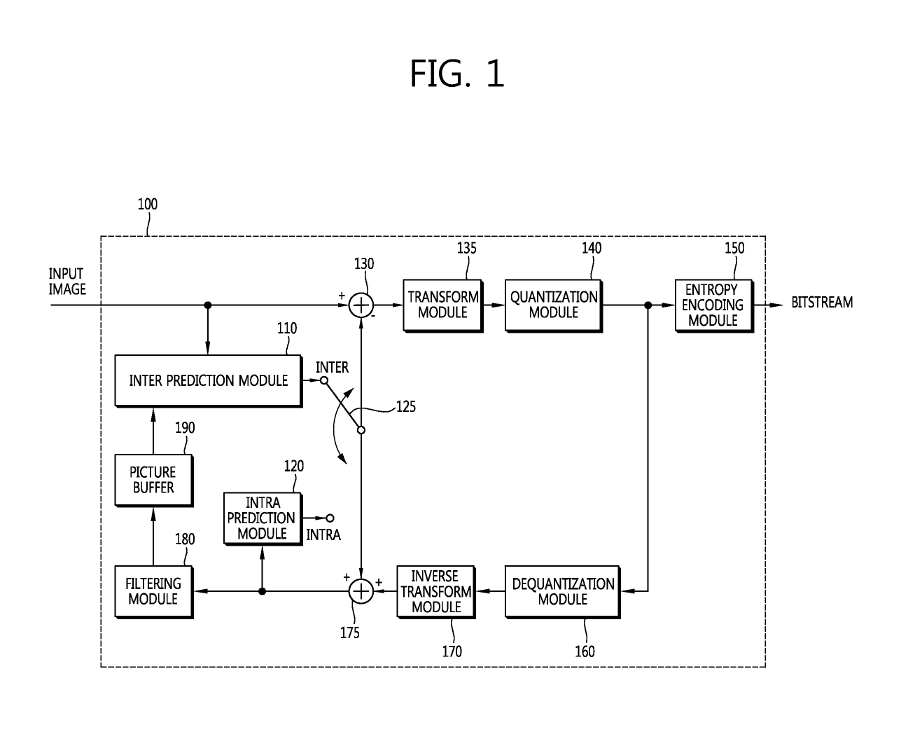

FIG. 1 is a block diagram illustrating a basic structure of an encoding apparatus according to an embodiment.

Referring to FIG. 1, an encoding apparatus 100 includes an inter prediction module 110, an intra prediction module 120, a switch 125, a subtractor 130, a transform module 135, a quantization module 140, an entropy encoding module 150, an dequantization module 160, an inverse transform module 170, an adder 175, a filter module 180, and a picture buffer 190.

The encoding apparatus 100 may encode an input image in an intra mode or in an inter mode to output a bitstream. The switch 125 is switched into intra in the intra mode and is switched into inter in the inter mode. The encoding apparatus 100 may generate a predicted block for an input block of an input image to encode a difference between the input block and the predicted block.

In the intra mode, the intra prediction module 120 may perform special prediction using a pixel value of a previously encoded block around a current block to generate the predicted block.

In the inter mode, the inter prediction module 110 may find a region corresponding to the input block in a reference image stored in the picture buffer 190 in a motion prediction process to obtain a motion vector. The inter prediction module 110 may perform motion compensation using the motion vector and a reference image stored in the picture buffer 190 to generate the predicted block.

The subtractor 130 may generate a residual block by a difference between the input block and the generated predicted block. The transform module 135 may transform the residual block to output a transform coefficient. The quantization module 140 may quantize an input transform coefficient in accordance with a quantization parameter to output a quantized coefficient.

The entropy encoding module 150 may entropy encode the quantized coefficient in accordance with a probability distribution based on values obtained by the quantization module 140 or an encoding parameter value obtained in an encoding process to output the bitstream.

The quantized coefficient may be dequantized by the dequantization module 160 and may be inverse transformed by the inverse transform module 170. The dequantized and inversed transformed coefficient may be added to the predicted block through the adder 175 so that a reconstructed block may be generated.

The reconstructed block passes the filter module 180 and the filter module 180 may apply at least one of a deblocking filter, sample adaptive offset (SAO), and an adaptive loop filter (ALF) to the reconstructed block or a reconstructed picture. The reconstructed block that passed through the filter module 180 may be stored in the picture buffer 190.

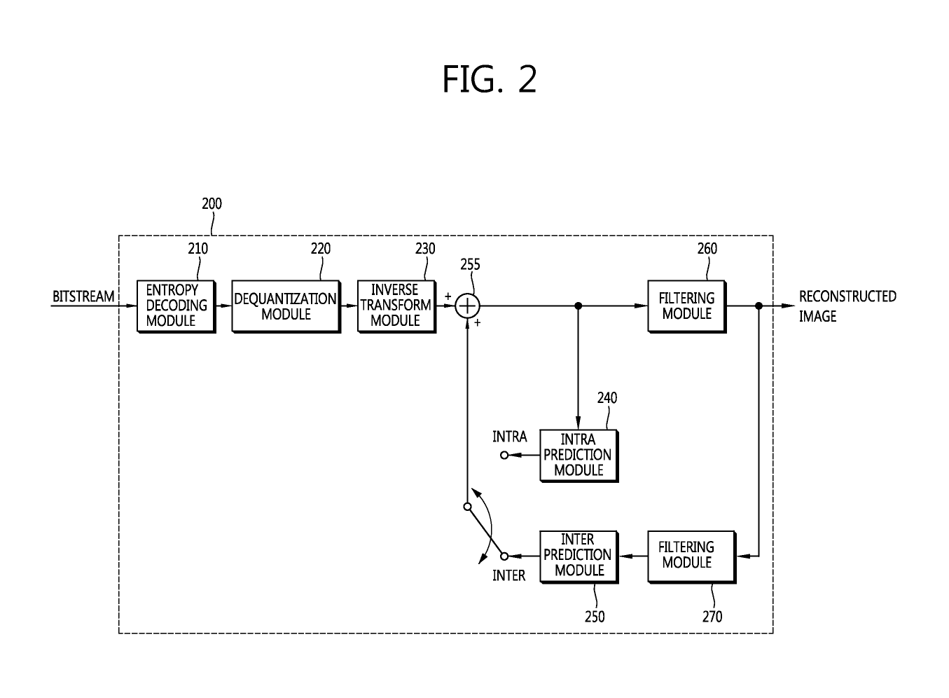

FIG. 2 is a block diagram illustrating a basic structure of a decoding apparatus according to an embodiment.

Referring to FIG. 2, a decoding apparatus 200 includes an entropy decoding module 210, an dequantization module 220, an inverse transform module 230, an intra prediction module 240, an inter prediction module 250, a filter module 260, and a picture buffer 270.

The decoding apparatus 200 may receive the bitstream output from the encoding apparatus to perform decoding in the intra mode or the inter mode and to output a reconfigured image, that is, a reconstructed image. The switch may be switched into intra in the intra mode and may be switched into inter in the inter mode.

The decoding apparatus 200 may obtain a reconstructed residual block from the received bitstream, generate a predicted block, and generate a reconfigured block, that is, a reconstructed block by adding the reconstructed residual block and the predicated block.

The entropy decoding module 210 may entropy decode the received input bitstream in accordance with a probability distribution. A quantized (transformed) coefficient may be generated by performing entropy decoding. The quantized coefficient may be dequantized by the dequantization module 220 and may be inverse transformed by the inverse transform module 230 so that the reconstructed residual block may be generated as a result of dequantization/inverse transform the quantized coefficient.

In the intra mode, the intra prediction module 240 may perform special prediction using a pixel value of a previously encoded block around a current block to generate the predicted block.

In the inter mode, the inter prediction module 250 may perform motion compensation using a motion vector and a reference image stored in the picture buffer 270 to generate the predicted block.

The reconstructed residual block and the predicted block are added through the adder 255 and the added block passes through the filter module 260. The filter module 260 may apply at least one of the deblocking filter, the SAO, and the ALF to the reconstructed block or a reconstructed picture. The filter module 260 may output a reconfigured image, that is, a reconstructed image. The reconstructed image may be stored in the picture buffer 270 to be used for inter prediction.

As described above, the encoding apparatus and the decoding apparatus predict the current block in order to perform encoding/decoding.

Prediction may be performed by the encoding apparatus/the decoding apparatus, specifically, the prediction modules of the encoding apparatus/the decoding apparatus. The prediction module of the encoding apparatus may include, for example, the inter prediction module 110 and the intra prediction module 120 of FIG. 1. The prediction module of the decoding apparatus may include, for example, the intra prediction module 240 and the inter prediction module 250 of FIG. 2.

When the prediction mode of the current block is intra prediction, the prediction module may predict the current block based on pixels (reference samples) in a previously encoded current picture in accordance with the intra prediction mode of the current block. The prediction module may perform intra prediction in which the predicted block for the current block is generated from the reference samples.

In a scalable video coding (hereinafter, referred to as ‘SVC) method, redundancy between layers is removed using texture information, motion information, and a residual signal between the layers to improve encoding/decoding performances. In the SVC method, various scalabilities may be provided in terms of spatial, temporal, and quality in accordance with neighboring conditions such as a transmission bit rate, a transmission error rate, and system resources.

In the SVC method, a structure of multiple layers may be used so that a bitstream that may be applied to various network environments may be provided. For example, in the SVC method, a base layer for processing image information using a common image encoding method and an enhancement layer for processing image information using the encoding information of the base layer and the common image encoding method may be included.

The layer structure may include a plurality of spatial layers, a plurality of temproal layers, and a plurality of quality layers. Images included in different spatial layers may have different special resolutions. Images included in different temporal layers may have different temporal resolutions (frame rates). In addition, images included in different quality layers may have different qualities, for example, different signal-to-noise ratios (SNR).

Here, a layer means a set of images and/or bitstreams distinguished from each other based on space (for example, the size of an image), time (for example, an encoding order and an image output order), picture quality, and complexity.

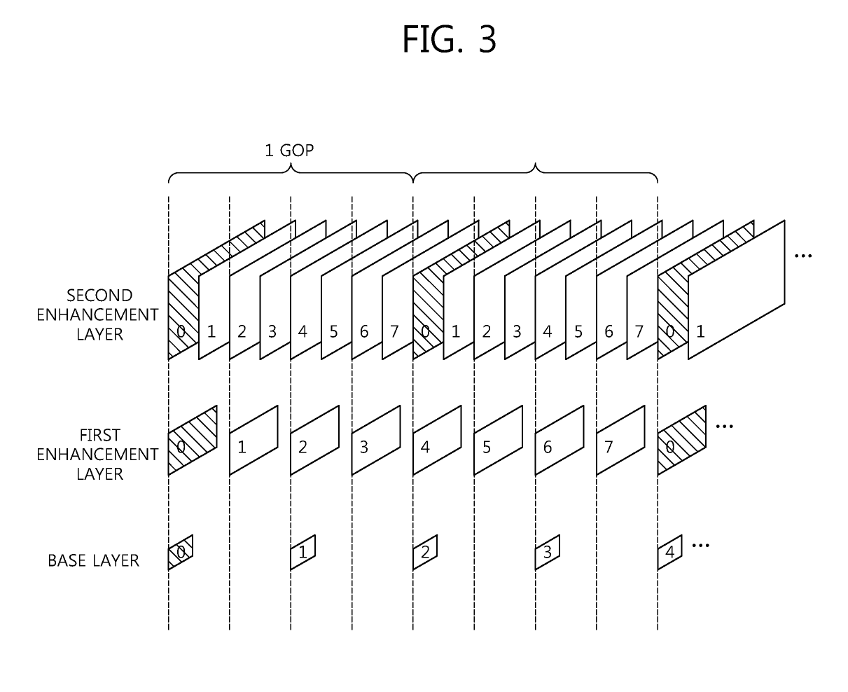

FIG. 3 is a conceptual diagram schematically illustrating an embodiment of a scalable video coding (SVC) using multiple layers according to the present invention. In FIG. 3, a group of picture (GOP) represents a group of pictures.

Referring to FIG. 3, as described above, the SVC structure includes a plurality of layers. In FIG. 3, the pictures of the layers are arranged in accordance with a picture order count (POC). The layers, that is, a base layer and enhancement layers may have different bit rates, resolutions, and sizes. A bitstream of the base layer may include basic image information. A bitstream of the enhancement layers may include information on an image in which the quality (correctness, a size, and/or a frame rate) of the base layer is further improved.

Therefore, the layers may be encoded/decoded in consideration of different characteristics. For example, the encoding apparatus of FIG. 1 and the decoding apparatus of FIG. 2 may encode and decode the pictures of corresponding layers as illustrated in FIGS. 1 and 2.

In addition, the pictures of the layers may be encoded/decoded using information on another layer. For example, the pictures of the layers may be encoded and decoded through inter layer prediction using the information on another layer. Therefore, in the SVC structure, the prediction modules of the encoding apparatus and the decoding apparatus illustrated in FIGS. 1 and 2 may perform prediction using the information on another layer, that is, a reference layer. The prediction modules of the encoding apparatus and the decoding apparatus may perform inter layer texture prediction, inter layer motion information prediction, and inter layer residual signal prediction using the information on another layer.

In the inter layer texture prediction, texture of a current layer (a layer to be encoded or decoded) is predicted based on texture information on another layer. In the inter layer motion information prediction, motion information on the current layer is predicted based on motion information (a motion vector and a reference picture) on another layer. In the inter layer residual signal prediction, the residual signal of the current layer is predicted based on the residual signal of another layer.

Since the current layer is encoded and decoded using the information on another layer, it is possible to reduce complexity of processing redundant information among layers and to reduce overhead of transmitting redundant information.

In the SVC, in performing the inter layer prediction, when resolutions between layers are different from each other, reconstructed samples of the reference layer may be performed upsampling and the upsampled reconstructed samples may be used as predicted signals for the enhancement layers. At this time, the reconstructed samples of the reference layer may be reconstructed samples to which the in-loop filter such as the deblocking filter, the SAO and the ALF is applied. The encoding apparatus may encode a residual signal obtained from a predicted signal and an original signal for an object block of an enhancement layer and transmit the encoded residual signal. The decoding apparatus may add the residual signal that are received from the encoding apparatus and a predicted signal obtained from the reference layer and generate a reconstructed signal for the object block.

The deblocking filter removes artifacts among blocks in accordance with prediction, transform, and quantization in units of blocks. The deblocking filter is applied to a prediction unit edge or a transform unit edge. A predetermined smallest block size for applying the deblocking filter may be set.

In order to apply the deblocking filter, first, the boundary strength (BS) of a horizontal or vertical filter boundary is determined Whether filtering is to be performed based on the BS is determined in units of blocks. When it is determined to perform filtering, it is determined which filter is to be applied. The filter to be applied may be selected from a weak filter and a strong filter. A filtering module applies the selected filter to the boundary of a corresponding block.

The SAO is a process of reconstructing an offset difference between a deblocking filtered image and an original image in units of pixels. A coding error may be compensated for through the SAO. The coding error may be caused by quantization. As described above, the SAO includes two types, band offset and edge offset. When the band offset is applied, samples of the blocks to which the SAO is applied are distinguished into bands in accordance with intensity. Predetermined offset is applied by band. In the band offset, an applied offset value may be determined by band to be signaled from the encoding apparatus to the decoding apparatus. The decoding apparatus may apply the offset value corresponding to a band to which an object pixel belongs to the object pixel based on the received offset value.

In the edge offset, the direction of an edge based on a current pixel is considered to apply offset in accordance with an intensity relation between the current pixel and a neighboring pixel. The direction of the edge may be divided into 0 degree, 90 degrees, 135 degrees, and 45 degrees. An intensity relation between the current pixel and a neighbor pixel may be divided into a case in which the intensity of the current pixel is smaller than the intensities of two neighbor pixels, a case in which the intensity of the current pixel is larger than the intensities of the two neighbor pixels, a case in which the intensity of the current pixel is larger than the intensity of a neighbor pixel and is equal to the intensity of another neighbor pixel, and a case in which the intensity of the current pixel is smaller than the intensity of a neighbor pixel and is equal to the intensity of another neighbor pixel. An offset value in accordance with the edge direction and/or the intensity relation between the current pixel and the neighbor pixels may be determined by the encoding apparatus to be signaled to the decoding apparatus. The decoding apparatus may apply the offset value corresponding to the category (the intensity relation between the current pixel and the neighbor pixels and/or the edge direction) of the object pixel to the object pixel based on the signaled offset value.

The ALF compensates for an coding error using a Wiener filter. The ALF is globally applied to a slice unlike the SAO. The ALF may be applied after applying the SAO and may be applied only to the case of high efficiency (HE). Information (a filter coefficient, on/off information, and a filter shape) for applying the ALF may be transmitted to a decoder through a slice header. Various symmetrical filters such as a two dimensional diamond-shaped filter and a two dimensional cross-shaped filter may be used for the ALF.

In-loop filters are applied to blocks (samples or sample signals) reconstructed by prediction. Whether to apply the deblocking filter, the SAO, and the ALF may be independently determined. When the deblocking filter is applied, at least one of the SAO and the ALF may be applied.

On the other hand, in the SVC, when the inter layer texture prediction is applied, the predicted signal for the current block of the enhancement layer may be generated based on the reconstructed samples of the reference layer to which the deblocking filter is applied. The encoding apparatus may obtain a difference between the original signal and the predicted signal of the block to be encoded (the current block) to encode the obtained difference and to transmit the encoded difference. The difference is transmitted in order to reduce a transmission amount and to improve encoding efficiency. However, the difference between the predicted signal obtained from the reference layer and the original signal may be large due to distortion of signals in accordance with a difference in the sizes of images between the layers.

Therefore, a method of applying filtering and offset capable of minimizing an error between the reconstructed samples obtained from the reference layer and the original sample of the enhancement layer to improve the correctness of the predicted signal may be considered. When the correctness of the predicted signal is improved by applying additional filtering and offset, the difference between the predicted signal and the original signal may be further reduced or the current block may be encoded and decoded without encoding the difference.

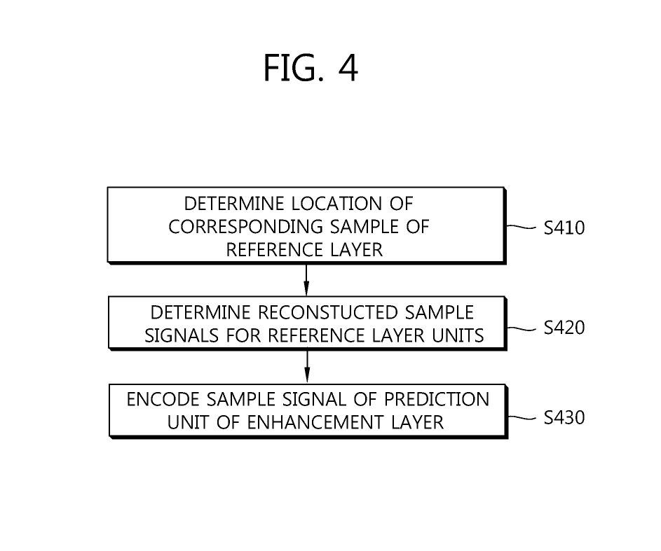

FIG. 4 is a flowchart schematically illustrating a method of encoding an enhancement layer in the encoding apparatus according to the present invention.

In FIG. 4, an example of encoding sample signals of a predicted unit (a current unit or a current block) to be currently encoded for an input image of an enhancement layer based on information on the reconstructed signals of the reference layer is illustrated.

Referring to FIG. 4, first, the encoding apparatus determines the location of a corresponding sample of the reference layer (S410). The location of the corresponding sample of the reference layer means the location of a sample of the reference layer corresponding to the location of a reference sample of the current unit (the predicted unit to be currently encoded) of the enhancement layer.

Next, the encoding apparatus determines reconstructed sample signals for the reference layer units (S420). For example, the encoding apparatus may obtain at least one reconstructed sample signal for the unit including the location of the corresponding sample of the reference layer and neighboring units of the unit.

Next, the encoding apparatus encodes the sample signal of the enhancement layer unit (S430). For example, the encoding apparatus may encode the sample signal of the current unit in the enhancement layer using the reconstructed sample signals of the reference layer.

Hereinafter, a method of encoding the enhancement layer illustrated in FIG. 4 will be described in detail.

First, the encoding apparatus determines the location of the sample of the reference layer corresponding to the location of the reference sample of the predicted unit (the current unit or the current block) to be currently encoded of the enhancement layer (S410).

The reference sample for specifying the location of the current unit may be a sample in the current unit and a sample outside the current unit.

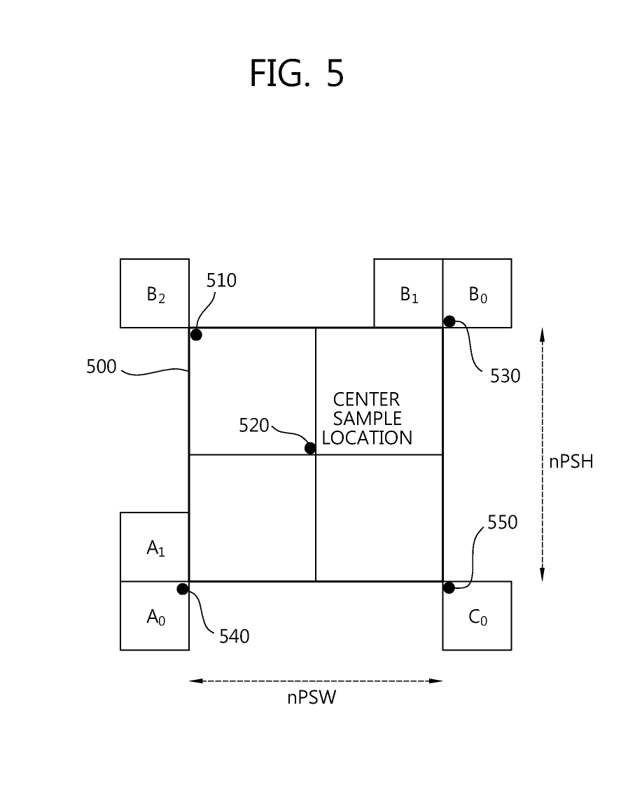

FIG. 5 is a view schematically illustrating an example of a method of determining reference samples of a current unit (a unit to be currently encoded or a unit to be currently decoded) and a method of specifying a unit of a reference layer using the same.

Referring to FIG. 5, a left upper end sample 510, a center sample 520, a right upper end sample 530, a left lower end sample 540, and a right lower end sample 550 may be reference samples for the predicted unit (the current unit 500) to be currently encoded.

At this time, the locations of the samples of the reference layer corresponding to the reference samples may be derived as follows. The location (refxP, refyP) of the sample of the reference layer corresponding to the location of the left upper end sample 510 of the current unit (the predicted unit to be currently encoded) may be derived as (refxP, refyP)=(xP, yP)/scaling factor when the location of the left upper end sample 510 of the current unit of the enhancement layer is (xP, yP).

The location (refxP, refyP) of the sample of the reference layer corresponding to the location of the center sample 520 of the current unit may be derived as (refxP, refyP)=(xPCtr, yPCtr)/scaling factor when the location of the center sample 520 of the current unit of the enhancement layer is (xPCtr, yPCtr). At this time, in FIG. 5, the location of the center sample 520 of the current unit of the enhancement layer is illustrated as the location of a center left upper sample. However, the present invention is not limited to the above and the location of a center left lower sample, the location of a center right upper sample, or the location of a center right lower sample may be used as the location of the center sample.

Therefore, (xPCtr, yPCtr) that is the location of the center sample 520 may be determined at least one of (xP+(nPSW>>1)−1, yP+(nPSH>>1)−1) corresponding to the location of the center left upper sample, (xP+(nPSW>>1)−1, yP+(nPSH>>1)) corresponding to the location of the center left lower sample, (xP+(nPSW>>1), yP+(nPSH>>1)−1) corresponding to the location of the center right upper sample, or (xP+(nPSW>>1), yP+(nPSH>>1)) corresponding to the location of the center right lower sample. At this time, nPSH represents the vertical length of the current unit (the predicated unit to be currently encoded) and nPSW represents the horizontal length of the current unit.

The location (refxP, refyP) of the sample of the reference layer corresponding to the location of the right upper end sample 530 of the current unit may be derived as (refxP, refyP)=(xPRt, yPRt)/scaling factor when the location of the right upper end sample 530 of the current unit of the enhancement layer is (xPRt, yPRt). At this time, the location (xPRt, yPRt) of the right upper end sample is (xP+nPSW, yP−1).

The location (refxP, refyP) of the sample of the reference layer corresponding to the location of the left lower end sample 540 of the current unit may be derived as (refxP, refyP)=(xPLb, yPLb)/scaling factor when the location of the left lower end sample 540 of the current unit of the enhancement layer is (xPLb, yPLb). At this time, the location (xPLb, yPLb) of the left lower end sample is (xP−1, yP+nPSH).

The location (refxP, refyP) of the sample of the reference layer corresponding to the location of the right lower end sample 550 of the current unit may be derived as (refxP, refyP)=(xPRb, yPRb)/scaling factor when the location of the right lower end sample 550 of the current unit of the enhancement layer is (xPRb, yPRb). At this time, the location (xPRb, yPRb) of the right lower end sample is (xP+nPSW, yP+nPSH).

Likely, the location (refxP, refyP) of the sample of the reference layer corresponding to the location (xPk, yPk) of an arbitrary sample of the current unit may be derived as (xPk, yPk)/scaling factor.

At this time, the scaling factor is a ratio between the size of the input image of the enhancement layer and the size of the input image of the reference layer for obtaining the location of the sample of the reference layer corresponding to the enhancement layer when the sizes of the input images of the layers are different from each other.

Therefore, the value of the scaling factor sf_X used by the decoding apparatus may be determined as illustrated in Equation 1.

sf=the size of the input image of the enhancement layer/the size of the input image of the reference layer [Equation 1]

For example, when the sizes of the input images of the layers are the same, the value of the scaling factor may be 1. When the horizontal/vertical sizes of the input image of the enhancement layer is twice larger than the horizontal/vertical sizes of the input image of the reference layer, the value of the scaling factor may be 2.

As described above, dividing the location of the sample by the scaling factor (for example, (xP, yP)/scaling factor) may mean dividing the x component and the y component of the location of the sample by the scaling factor, respectively. At this time, in the ratio of the size of the input image, the ratio of the size of the horizontal component may be different from the ratio of the size of the vertical component. In this case, the ratio sf_X of the size of the horizontal component and the ratio sf_Y of the size of the vertical component may be determined as illustrated in Equation 2.

sf_{—}X=the horizontal size of the input image of the enhancement layer/the horizontal size of the input image of the reference layer

sf_{—}Y=the vertical size of the input image of the enhancement layer/the vertical size of the input image of the reference layer [Equation 2]

Therefore, when the location of the sample of the enhancement layer is (xE, yE), the location (refxP, refyP) of the corresponding sample in the reference layer is illustrated in Equation 3.

(refxP,refyP)=(xE/sf_{—}X,yE/sf_{—}Y) [Equation 3]

For example, if the value of the scaling factor sf_X of the horizontal component is 2 and the value of the scaling factor sf_Y of the vertical component is 1.5, when the location of the sample of the enhancement layer is (xP, yP), the location of the corresponding sample in the reference layer is (xP/2, yP/1.5).

Various locations other than the locations illustrated in FIG. 5 may be used as the locations of the reference samples for the current unit of the enhancement layer. In FIG. 5, an example of the reference samples is illustrated. However, the present invention is not limited to the above. For example, the location of the right lower end sample in a block B2 may be used as the location of the left upper end sample instead of the location of the sample 510 in the current unit. The location of the right upper end sample in the current unit or the location of the right lower end sample in a block B1 may be used as the location of the right upper end sample instead of the location of the sample 530 in B0. In addition, the location of the left lower end sample in the current unit or the location of the right lower end sample in A1 may be used as the location of the left lower end sample instead of the location of the sample 540 in A0. Likely, the location of the right lower end sample in the current unit may be used as the location of the right lower end sample instead of the location of the sample 550 in C0.

On the other hand, when the sizes of the images of the layers are different from each other, first, entire image signals are scaled so that the sizes of the images are made equal and the locations of the samples of the reference layer corresponding to the locations of the reference samples of the current unit may be obtained. In this case, the samples of the reference layer whose locations are the same as the locations of the reference samples of the current unit may be used as the samples of the reference layer corresponding to the reference samples of the current unit.

The locations of the samples of the reference layer corresponding to the locations of the reference samples of the current unit (the predicated unit to be currently encoded) of the enhancement layer may be obtained using the above-described method (at least one of the above-described methods).

Returning to FIG. 4, the encoding apparatus may obtain the reconstructed sample signals for at least one of the unit including the locations of the samples of the reference layer corresponding to the enhancement layer and the neighboring units (S420).

In encoding the reference layer, when filtering such as an adaptive deblocking filter (ADF), the SAO, and the ALF is applied to the reconstructed sample signals, the reconstructed sample signals of the reference layer used for inter layer texture prediction may be selected from a plurality of locations. Here, the locations may mean before or after the filter or the offset is applied. That is, the reconstructed samples of the reference layer used for inter layer texture prediction may be selected among a plurality of samples. At this time, the reconstructed samples may be samples to which the in-loop filter is applied and samples to which the in-loop filter is not applied.

For example, the encoding apparatus may use the reconstructed sample signals before the ADF is applied as the reconstructed sample signals of a reference unit and may use the reconstructed sample signals after the ADF is applied as the reconstructed sample signals of the reference unit. In addition, the encoding apparatus may use the reconstructed sample signals before the SAO is applied as the reconstructed sample signals of the reference unit and may use the reconstructed sample signals after the SAO is applied as the reconstructed sample signals of the reference unit. In addition, the encoding apparatus may use the reconstructed sample signals before the ALF is applied as the reconstructed sample signals of the reference unit and may use the reconstructed sample signals after the ALF is applied as the reconstructed sample signals of the reference unit.

Therefore, when the above-described example is referred to again, the reconstructed sample signals of the reference unit may be determined in consideration of a process of applying the in-loop filter to the reconstructed sample signals in the reference layer. At this time, the reference unit means a unit including the locations of the samples of the reference layer corresponding to the locations of the samples of the enhancement layer or neighboring units.

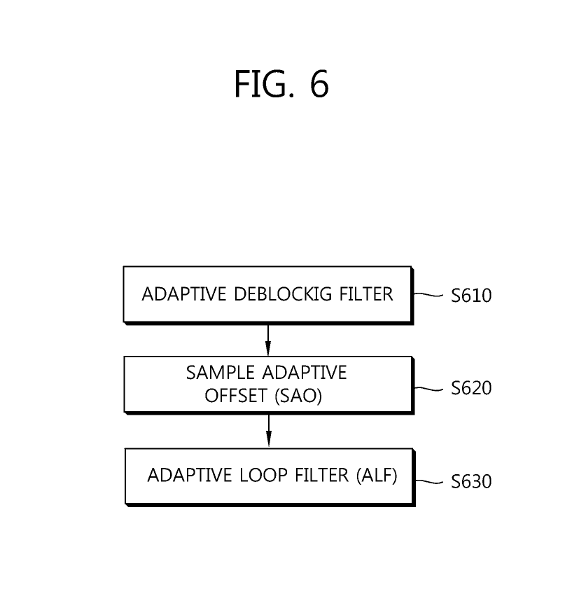

FIG. 6 is a flowchart schematically illustrating an example of a method of applying the in-loop filter.

Referring to FIG. 6, the in-loop filter includes a process of applying the ADF (S610), a process of applying the SAO (S620), and a process of applying the ALF (S630). At this time, the ADF, the SAO, and the ALF may be selectively applied and whether to apply the ADF, the SAO, and the ALF may be determined only when preceding filter or offset is applied.

When the example of the method of applying the in-loop of FIG. 6 is considered, the encoding apparatus may determine the reconstructed sample signals of the reference unit as one of (1) the reconstructed sample signals before applying the ADF, (2) the reconstructed sample signals after applying the ADF and before applying the SAO, (3) the reconstructed sample signals after applying the ADF and the SAO and before applying the ALF, and (4) the reconstructed sample signals after applying the ADF, the SAO, and the ALF. The example of FIG. 6 is an embodiment of the present invention. In applying the present invention, the order of applying the ADF, the SAO, and the ALF is not limited to FIG. 6 but may be one of ADF→ALF→SAO, SAO→ADF→ALF, SAO→ALF→ADF, ALF→SAO→ADF, and ALF→ADF→SAO as well as ADF→SAO→ALF illustrated in FIG. 6. In addition, the reconstructed sample signals of the reference unit may be determined before and after applying the ADF, the SAO, and the ALF, respectively, when all of the ADF, the SAO, and the ALF may be applied, and may be determined before and after the applied filter or offset when at least one of the ADF, the SAO, and the ALF is applied.

The encoding apparatus may transmit information on the reconstructed sample signals of the reference unit (information on the location of the reference unit and/or the reconstructed sample signals of the reference unit) to the decoding apparatus.

On the other hand, it is described that the locations of the reference samples are determined using all of the above-described methods and the locations of the corresponding samples of the reference layer are specified. However, the present invention is not limited to the above and one of the locations of the reference samples may be specified so that a predicted signal may be generated using a reference unit specified based on the specified location.

Returning to FIG. 4, the encoding apparatus may encode the sample signals of the current unit (the predicted unit to be currently encoded) of the enhancement layer using the reconstructed reference sample signals of the reference layer (S430).

At this time, the reconstructed reference sample signals are obtained from the reference unit. As described above, the reference unit means the unit including the samples of the reference layer corresponding to the locations of the reference samples of the current unit obtained through S410 and S420 or neighboring units. When the sizes of the images of the layers are different from each other, the size of the reference unit is scaled in accordance with the ratio (the scaling factor) between the sizes of the images of the layers to be used for encoding the current unit.

A reconstructed sample signal of the reference unit may be used as a predicted sample signal of the current unit so that a differential signal between the reconstructed sample signal of the reference unit and the original sample signal of the current unit may be obtained. The encoding apparatus may encode the differential signal to transmit the encoded differential signal to the decoding apparatus.

The encoding apparatus may use the reconstructed sample signal of the reference unit as an encoding signal of the current unit. For example, when it is determined that the reconstructed sample signal of the reference unit is the same as the original sample signal of the current unit, the encoding apparatus may not generate the differential signal for the current unit or may not decode the differential signal.

The encoding apparatus may obtain a filter coefficient of minimizing an error or a difference between the reconstructed sample signal of the reference unit and the original sample signal of the current unit. The encoding apparatus may filter the reconstructed sample signal of the reference unit using the obtained filter coefficient to minimize the differential signal for the current unit.

The encoding apparatus may use the reconstructed sample signal of the reference unit obtained by applying a filter of minimizing the differential signal as the predicted signal of the current unit. The encoding apparatus may obtain the differential signal between the predicted signal of the current unit and the original sample signal of the current unit and encode the obtained differential signal. In this case, as described above, when it is determined that the reconstructed sample signal of the reference unit obtained by applying the filter of minimizing the differential signal is the same as the original sample of the current unit or when the filter of minimizing the differential signal is applied, it is set that the reconstructed sample signal of the reference unit is the same as the original sample signal of the current unit and the encoding apparatus may not encode the differential signal for the current unit.

An adaptive filter coefficient or a fixed filter coefficient may be used as the filter coefficient used for filtering the reconstructed sample signal of the reference unit. When the adaptive filter coefficient is used, the encoding apparatus may adaptively determine the filter coefficient to correspond to the current unit and/or the reference unit. In this case, the encoding apparatus may encode information on the filter coefficient so that the same filter coefficient may be used by the decoding apparatus to transmit the encoded information to the decoding apparatus.

At this time, when the sizes of the images of the layers are different from each other, the reconstructed sample signal of the reference unit used for obtaining the filter coefficient of minimizing the difference (the error) between the reconstructed sample signal of the reference unit and the original sample signal of the current unit may be a reconstructed sample signal obtained after correcting the sizes of the images of the layers by applying scaling.

In addition, although the sizes of the images of the layers are different from each other, the reconstructed sample signal of the reference unit used for obtaining the filter coefficient of minimizing the difference (the error) between the reconstructed sample signal of the reference unit and the original sample signal of the current unit may be a reconstructed sample signal of the reference unit to which scaling is not applied or the reference layer to which scaling is not applied. In this case, the encoding apparatus may determine the filter coefficient of minimizing the difference (the error) in consideration of scaling and may have scaling reflected in a process of filtering the reconstructed sample signal of the reference unit using the filter coefficient.

Sample offset (for example, the SAO) other than the above-described filtering (for example, the deblocking filtering, the ALF, etc.) may be applied. The encoding apparatus may use the reconstructed sample signal obtained by adding a sample offset value to the reconstructed sample signal of the reference unit as the predicted signal of the current unit. The encoding apparatus may encode the differential signal between the predicted signal and the original sample signal of the current unit.

In addition, the encoding apparatus may use the reconstructed sample signal obtained by adding the sample offset value to the reconstructed sample signal of the reference unit as an encoding signal of the current unit (the predicted unit to be currently encoded) when it is determined that the reconstructed sample signal (the predicted signal) obtained by adding the sample offset value to the reconstructed sample signal of the reference unit is the same as the original sample signal of the current unit or when it is set that the predicted signal is the same as the original sample signal of the current unit.

A predetermined fixed offset value may be applied as the sample offset value. In addition, an adaptive offset value adaptively obtained from the reconstructed sample signal of the reference unit and the original sample signal of the current unit may be applied as the sample offset value. When the adaptive offset is used, the encoding apparatus may encode information on the offset so that the same offset value may be used by the decoding apparatus to transmit the encoded information.

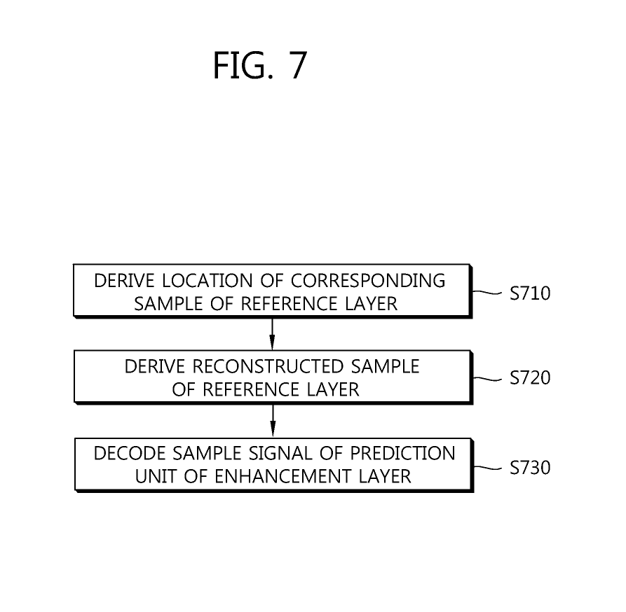

FIG. 7 is a flowchart schematically illustrating a method of decoding the enhancement layer in the decoding apparatus according to the present invention.

In FIG. 7, an example of decoding the sample signal of the predicted unit to be currently decoded (the current unit or the current block) for the input image of the enhancement layer based on information on the reconstructed signal of the reference layer is illustrated.

Referring to FIG. 7, first, the decoding apparatus derives the location of the corresponding sample of the reference layer (S710). The location of the corresponding sample of the reference layer means the location of the sample of the reference layer corresponding to the location of the reference sample of the current unit (the predicted unit to be currently decoded) of the enhancement layer.

Next, the decoding apparatus derives the reconstructed sample signal of the reference layer (S720). For example, the decoding apparatus may derive the reconstructed sample signal for the reference unit.

Next, the decoding apparatus decodes the sample signal of a unit (the predicted unit to be currently decoded of the enhancement layer: the current unit) of the enhancement layer (S730). For example, the decoding apparatus may decode the sample signal of the current unit in the enhancement layer using the reconstructed sample signal of the reference layer.

Hereinafter, the method of decoding the enhancement layer illustrated in FIG. 7 will be described in detail.

First, the decoding apparatus determines the location of the sample of the reference layer corresponding to the location of the reference sample of the predicted unit to be currently decoded (the current unit or the current block) of the enhancement layer (S710).

The reference sample for specifying the location of the current unit may be a sample in the current unit and a sample outside the current unit.

FIG. 5 is a view schematically illustrating an example of a method of determining reference samples of a current unit (a unit to be currently decoded or a unit to be currently encoded) and a method of specifying a unit of a reference layer using the same.

Referring to FIG. 5, a left upper end sample 510, a center sample 520, a right upper end sample 530, a left lower end sample 540, and a right lower end sample 550 may be reference samples for the predicted unit (the current unit 500) to be currently decoded.

At this time, the locations of the samples of the reference layer corresponding to the reference samples may be derived as follows. The location (refxP, refyP) of the sample of the reference layer corresponding to the location of the left upper end sample 510 of the current unit (the predicted unit to be currently decoded) may be derived as (refxP, refyP)=(xP, yP)/scaling factor when the location of the left upper end sample 510 of the current unit of the enhancement layer is (xP, yP).

The location (refxP, refyP) of the sample of the reference layer corresponding to the location of the center sample 520 of the current unit may be derived as (refxP, refyP)=(xPCtr, yPCtr)/scaling factor when the location of the center sample 520 of the current unit of the enhancement layer is (xPCtr, yPCtr). At this time, in FIG. 5, the location of the center sample 520 of the current unit of the enhancement layer is illustrated as the location of a center left upper sample. However, the present invention is not limited to the above and the location of a center left lower sample, the location of a center right upper sample, or the location of a center right lower sample may be used as the location of the center sample.

Therefore, (xPCtr, yPCtr) that is the location of the center sample 520 may be determined as one of (xP+(nPSW>>1)−1, yP+(nPSH>>1)−1) corresponding to the location of the center left upper sample, (xP+(nPSW>>1)−1, yP+(nPSH>>1)) corresponding to the location of the center left lower sample, (xP+(nPSW>>1), yP+(nPSH>>1)−1) corresponding to the location of the center right upper sample, or (xP+(nPSW>>1), yP+(nPSH>>1)) corresponding to the location of the center right lower sample. At this time, nPSH represents the vertical length of the current unit (the predicated unit to be currently decoded) and nPSW represents the horizontal length of the current unit.

The location (refxP, refyP) of the sample of the reference layer corresponding to the location of the right upper end sample 530 of the current unit may be derived as (refxP, refyP)=(xPRt, yPRt)/scaling factor when the location of the right upper end sample 530 of the current unit of the enhancement layer is (xPRt, yPRt). At this time, the location (xPRt, yPRt) of the right upper end sample is (xP+nPSW, yP−1).

The location (refxP, refyP) of the sample of the reference layer corresponding to the location of the left lower end sample 540 of the current unit may be derived as (refxP, refyP)=(xPLb, yPLb)/scaling factor when the location of the left lower end sample 540 of the current unit of the enhancement layer is (xPLb, yPLb). At this time, the location (xPLb, yPLb) of the left lower end sample is (xP−1, yP+nPSH).

The location (refxP, refyP) of the sample of the reference layer corresponding to the location of the right lower end sample 550 of the current unit may be induced as (refxP, refyP)=(xPRb, yPRb)/scaling factor when the location of the right lower end sample 550 of the current unit of the enhancement layer is (xPRb, yPRb). At this time, the location (xPRb, yPRb) of the right lower end sample is (xP+nPSW, yP+nPSH).

Likely, the location (refxP, refyP) of the sample of the reference layer corresponding to the location (xPk, yPk) of an arbitrary sample of the current unit may be derived as (xPk, yPk)/scaling factor.

At this time, the scaling factor is a ratio between the size of the input image of the enhancement layer and the size of the input image of the reference layer for obtaining the location of the sample of the reference layer corresponding to the enhancement layer when the sizes of the input images of the layers are different from each other.

Therefore, the value of the scaling factor sf_X used by the decoding apparatus may be determined as illustrated in Equation 4.

sf=the size of the input image of the enhancement layer/the size of the input image of the reference layer [Equation 4]

For example, when the sizes of the input images of the layers are the same, the value of the scaling factor may be 1. When the horizontal/vertical sizes of the input image of the enhancement layer are twice larger than the horizontal/vertical sizes of the input image of the reference layer, the value of the scaling factor may be 2.

As described above, dividing the location of the sample by the scaling factor (for example, (xP, yP)/scaling factor) may mean dividing the x component and the y component of the location of the sample by the scaling factor, respectively. At this time, in the ratio of the size of the input image, the ratio of the size of the horizontal component may be different from the ratio of the size of the vertical component. In this case, the ratio sf_X of the size of the horizontal component and the ratio sf_Y of the size of the vertical component may be determined as illustrated in Equation 5.

sf_{—}X=the horizontal size of the input image of the enhancement layer/the horizontal size of the input image of the reference layer

sf_{—}Y=the vertical size of the input image of the enhancement layer/the vertical size of the input image of the reference layer [Equation 5]

Therefore, when the location of the sample of the enhancement layer is (xE, yE), the location (refxP, refyP) of the corresponding sample in the reference layer is illustrated in Equation 6.

(refxP,refyP)=(xE/sf_{—}X,yE/sf_{—}Y) [Equation 6]

For example, if the value of the scaling factor sf_X of the horizontal component is 2 and the value of the scaling factor sf_Y of the vertical component is 1.5, when the location of the sample of the enhancement layer is (xP, yP), the location of the corresponding sample in the reference layer is (xP/2, yP/1.5).

Various locations other than the locations illustrated in FIG. 5 may be used as the locations of the reference samples for the current unit of the enhancement layer. In FIG. 5, an example of the reference samples is illustrated. However, the present invention is not limited to the above. For example, the location of the right lower end sample in a block B2 may be used as the location of the left upper end sample instead of the location of the sample 510 in the current unit. The location of the right upper end sample in the current unit or the location of the right lower end sample in a block B1 may be used as the location of the right upper end sample instead of the location of the sample 530 in B0. In addition, the location of the left lower end sample in the current unit or the location of the right lower end sample in A1 may be used as the location of the left lower end sample instead of the location of the sample 540 in A0. Likely, the location of the right lower end sample in the current unit may be used as the location of the right lower end sample instead of the location of the sample 550 in C0.

On the other hand, when the sizes of the images of the layers are different from each other, first, entire image signals are scaled so that the sizes of the images are made equal and the locations of the samples of the reference layer corresponding to the locations of the reference samples of the current unit may be obtained. In this case, the samples of the reference layer whose locations are the same as the locations of the reference samples of the current unit may be used as the samples of the reference layer corresponding to the reference samples of the current unit.

The locations of the samples of the reference layer corresponding to the locations of the reference samples of the current unit (the predicated unit to be currently decoded) of the enhancement layer may be obtained using the above-described method (at least one of the above-described methods).

Returning to FIG. 7, the decoding apparatus may obtain the reconstructed sample signals for at least one of the unit including the locations of the samples of the reference layer corresponding to the enhancement layer and the neighboring units (S720).

In decoding the reference layer, when filtering such as an adaptive deblocking filter (ADF), the SAO, and the ALF is applied to the reconstructed sample signals, the reconstructed sample signals of the reference layer used for inter layer texture prediction may be selected from a plurality of locations. Here, the locations may mean before or after the filter or the offset is applied. That is, the reconstructed samples of the reference layer used for inter layer texture prediction may be selected among a plurality of samples. At this time, the reconstructed samples may be samples to which the in-loop filter is applied and samples to which the in-loop filter is not applied.

For example, the decoding apparatus may use the reconstructed sample signals before the ADF is applied as the reconstructed sample signals of a reference unit and may use the reconstructed sample signals after the ADF is applied as the reconstructed sample signals of the reference unit. In addition, the decoding apparatus may use the reconstructed sample signals before the SAO is applied as the reconstructed sample signals of the reference unit and may use the reconstructed sample signals after the SAO is applied as the reconstructed sample signals of the reference unit. In addition, the decoding apparatus may use the reconstructed sample signals before the ALF is applied as the reconstructed sample signals of the reference unit and may use the reconstructed sample signals after the ALF is applied as the reconstructed sample signals of the reference unit.

FIG. 6 is a flowchart schematically illustrating an example of a method of applying the in-loop filter.

Referring to FIG. 6, the in-loop filter includes a process of applying the ADF (S610), a process of applying the SAO (S620), and a process of applying the ALF (S630). At this time, the ADF, the SAO, and the ALF may be selectively applied and whether to apply the ADF, the SAO, and the ALF may be determined only when preceding filter or offset is applied.

The decoding apparatus may apply the in-loop filter based on information on application of the in-loop filter transmitted from the encoding apparatus.

When the example of the method of applying the in-loop of FIG. 6 is considered, the decoding apparatus may determine the reconstructed sample signals of the reference unit as one of (1) the reconstructed sample signals before applying the ADF, (2) the reconstructed sample signals after applying the ADF and before applying the SAO, (3) the reconstructed sample signals after applying the ADF and the SAO and before applying the ALF, and (4) the reconstructed sample signals after applying the ADF, the SAO, and the ALF. The example of FIG. 6 is an embodiment of the present invention. In applying the present invention, the order of applying the ADF, the SAO, and the ALF is not limited to FIG. 6 but may be one of ADF→ALF—SAO, SAO→ADF→ALF, SAO→ALF→ADF, ALF→SAO→ADF, and ALF→ADF→SAO as well as ADF→SAO→ALF illustrated in FIG. 6. In addition, the reconstructed sample signals of the reference unit may be determined before and after applying the ADF, the SAO, and the ALF, respectively, when all of the ADF, the SAO, and the ALF may be applied, and may be determined before and after the applied filter or offset when at least one of the ADF, the SAO, and the ALF is applied.

When the information on the reconstructed sample signals of the reference unit (the information on the location of the reference unit and/or the reconstructed sample signals of the reference unit) is transmitted from the encoding apparatus, the decoding apparatus may decode the corresponding information to obtain information for determining the reconstructed sample signal. The decoding apparatus may derive the reconstructed sample signal from the reference unit of the location indicated by the information received from the encoding apparatus. That is, the decoding apparatus may derive the reconstructed sample signal of the reference unit indicated by the encoding apparatus in order to decode the sample signal of the current unit.

In addition, the decoding apparatus may receive information indicating the reference sample instead of information indicating the reference unit from the encoding apparatus. The decoding apparatus may derive the reference unit specified by the indicated reference sample and may reconstruct the sample signal of the corresponding reference unit when the information indicating the reference sample is received.

Returning to FIG. 4, the decoding apparatus may decode the sample signals of the current unit (the predicted unit to be currently decoded) of the enhancement layer using the reconstructed reference sample signals of the reference layer (S730).

At this time, the reconstructed reference sample signals are obtained from the reference unit. As described above, the reference unit means the unit including the samples of the reference layer corresponding to the locations of the reference samples of the current unit obtained through S710 and S720 or neighboring units. When the sizes of the images of the layers are different from each other, the size of the reference unit is scaled in accordance with the ratio (the scaling factor) between the sizes of the images of the layers to be used for decoding the current unit.

The decoding apparatus may use the reconstructed sample signal of the reference unit as the predicted sample signal of the current unit (the predicted unit to be currently decoded). The decoding apparatus may add the differential signal transmitted from the encoding apparatus to the reconstructed sample signal of the reference unit to generate the reconstructed sample signal of the current unit.

The decoding apparatus may use the reconstructed sample signal of the reference unit as the reconstructed sample signal of the current unit without receiving the differential signal from the encoding apparatus. In this case, the decoding apparatus may receive indication or information that the reconstructed sample signal of the reference unit is the same as the original sample signal of the current unit from the encoding apparatus.

As described above with respect to the encoding apparatus, in order to minimize the error or difference between the reconstructed sample signal of the reference unit and the original sample signal of the current unit, an optimal filter coefficient is applied. The decoding apparatus may filter the reconstructed sample signal of the reference unit using the optimal filter coefficient to obtain the predicted sample signal of minimizing the differential signal for the current unit.

The decoding apparatus may use the reconstructed sample signal of the reference unit obtained by applying the filter of minimizing the differential signal as the predicted signal of the current unit. The decoding apparatus may add the predicted signal of the current unit to the differential signal received from the encoding apparatus to reconstruct the sample signal of the current unit. At this time, as described above, the decoding apparatus may use the reconstructed sample signal of the reference unit as the reconstructed sample signal of the current unit without the differential signal for the current unit being transmitted from the encoding apparatus.

An adaptive filter coefficient or a fixed filter coefficient may be used as the filter coefficient used for filtering the reconstructed sample signal of the reference unit. When the adaptive filter coefficient is used, the decoding apparatus receives information on the filter coefficient to be applied to the sample of the reference unit from the encoding apparatus. When the fixed filter coefficient is used, the decoding apparatus may filter the sample of the reference unit using a predetermined filter coefficient. Here, the predetermined filter coefficient may be a filter coefficient mounted between the encoding apparatus and the decoding apparatus and a filter coefficient transmitted at larger intervals than information on the adaptive filter coefficient.

On the other hand, when the sizes of the images of the layers are different from each other, the reconstructed sample signal of the reference unit to which filtering is applied may be a reconstructed sample signal obtained after correcting the sizes of the images of the layers by applying scaling.

In addition, although the sizes of the images of the layers are different from each other, filtering may be applied to the reconstructed sample signal of the reference unit to which scaling is not applied or the reference layer to which scaling is not applied. In this case, the filter coefficient may be a filter coefficient in which scaling is considered and scaling is reflected in the process of filtering the reconstructed sample signal of the reference unit.

The sample offset (for example, the SAO) other than the above-described filtering (for example, the deblocking filtering, the ALF, etc.) may be applied. For example, the reconstructed sample signal obtained by adding the sample offset value to the reconstructed sample signal of the reference unit may be used as the predicted signal of the current unit.

In this case, the decoding apparatus may add the differential signal received from the encoding apparatus to the predicted signal to reconstruct the sample signal of the current unit.

In addition, the decoding apparatus may use the reconstructed sample signal (the predicted signal) obtained by adding the sample offset value to the reconstructed sample signal of the reference unit as the reconstructed sample signal of the current unit without receiving the differential signal from the encoding apparatus. In this case, the decoding apparatus may receive the information indicating that the predicted signal is the same as the original sample signal of the current unit from the encoding apparatus.

A predetermined offset value may be applied as the sample offset value. In addition, the adaptive offset value may be applied as the sample offset value. When the adaptive offset is used, the decoding apparatus may receive offset information from the encoding apparatus. The decoding apparatus may decode the received offset information to obtain an offset value to be applied to the sample signal of the reference unit. Here, the predetermined offset value may be an offset value mounted between the encoding apparatus and the decoding apparatus and may be an offset value transmitted at larger intervals than the adaptive offset value.

In the specification, the predicted signal, the predicted sample, the predicted block, and the predicted sample signal are mixedly used for convenience sake. In the specification, the predicted signal, the predicted sample, the predicted block, and the predicted sample signal may have the same meaning.

In addition, in the specification, the predicted unit (to be currently encoded), the current unit, the current block, and the object block are mixedly used for convenience sake. In the specification, the predicted unit to be currently encoded, the current unit, the current block, and the object block may mean the block/processing unit block (unit) to be currently encoded or the block/processing unit block (unit) to be currently predicted.

In addition, in the above-described exemplary system, the methods are described based on the flowcharts as a series of processes or blocks. However, the present invention is not limited to the order of the processes but a certain process may be generated in a different order from another above-described process or may be simultaneously generated with another above-described process. In addition, those skilled in the art may understand that the processes illustrated in the flowcharts are not exclusive but another process may be include or one or more processes of the flowcharts may be deleted without affecting the scope of the present invention.

The above-described embodiments include various examples. All of the possible combinations for representing the various examples may not be described. However, those skilled in the art may know that another combination may be performed. Therefore, the present invention includes all of exchanges, modifications, and changes that belong to the following claims.

What is claimed is:

1. A method of encoding an image, comprising:
determining a location of a corresponding sample in a reference layer;
generating a reference sample signal by reconstructing a sample of a reference unit in a reference layer specified by the corresponding sample; and
encoding a differential signal between a sample signal of a current unit of an enhancement layer and the reference sample signal,
wherein the corresponding sample is a sample of the reference layer corresponding to a reference sample specifying the current unit.

2. The method of claim 1, wherein, in determining the location of the corresponding sample,
the location of the corresponding sample is determined by scaling the location of the corresponding sample in accordance with a ratio between a size of an image of the reference layer and a size of an image of the enhancement layer.

3. The method of claim 2, wherein a height component of the location of the corresponding sample is scaled in accordance with a ratio between a height of the image of the reference layer and a height of the image of the enhancement layer, and
a width component of the location of the corresponding sample is scaled in accordance with a ratio between a width of the image of the reference layer and a width of the image of the enhancement layer.

4. The method of claim 1, wherein, in generating the reference sample signal,
a size of the reference unit is scaled in accordance with a ratio between a size of an image of the reference layer and a size of an image of the enhancement layer.

5. The method of claim 4, wherein a height of the reference unit is scaled in accordance with a ratio between a height of the image of the reference layer and a height of the image of the enhancement layer, and
a width of the reference unit is scaled in accordance with a ratio between a width of the image of the reference layer and a width of the image of the enhancement layer.

6. The method of claim 1, wherein, in generating the reference sample signal,
the reference sample signal is generated by scaling the reconstructed sample in accordance with a ratio between a size of an image of the reference layer and a size of an image of the enhancement layer.

7. The method of claim 1, wherein, in generating the reference sample signal,
the reference sample signal is generated by applying filtering after reconstructing a sample of the reference unit.

8. The method of claim 7, wherein a filter coefficient used for the filtering is a filter coefficient of minimizing the differential signal.

9. The method of claim 1, wherein, in generating the reference sample signal,
the reference sample signal is generated by applying offset after reconstructing a sample of the reference unit.

10. The method of claim 9, wherein the offset is offset of minimizing the differential signal.

11. A method of decoding an image, comprising:
deriving a location of a corresponding sample in a reference layer;
generating a reference sample signal by reconstructing a sample of a reference unit in a reference layer specified by the corresponding sample; and
reconstructing a sample signal of a current unit in an enhancement layer based on a differential signal received from an encoder and the reference sample signal,
wherein the corresponding sample is a sample of the reference layer corresponding to a reference sample specifying the current unit.

12. the method of claim 11, wherein, in deriving the location of the corresponding sample,
the location of the corresponding sample is derived by scaling the location of the corresponding sample in accordance with a ratio between a size of an image of the reference layer and a size of an image of the enhancement layer.

13. The method of claim 12, wherein a height component of the location of the corresponding sample is scaled in accordance with a ratio between a height of the image of the reference layer and a height of the image of the enhancement layer, and
a width component of the location of the corresponding sample is scaled in accordance with a ratio between a width of the image of the reference layer and a width of the image of the enhancement layer.

14. The method of claim 11, wherein, in generating the reference sample signal,
a size of the reference unit is scaled in accordance with a ratio between a size of an image of the reference layer and a size of an image of the enhancement layer.

15. The method of claim 14, wherein a height of the reference unit is scaled in accordance with a ratio between a height of the image of the reference layer and a height of the image of the enhancement layer, and
a width of the reference unit is scaled in accordance with a ratio between a width of the image of the reference layer and a width of the image of the enhancement layer.

16. The method of claim 11, wherein, in generating the reference sample signal,
the reference sample signal is generated by scaling the reconstructed sample in accordance with a ratio between a size of an image of the reference layer and a size of an image of the enhancement layer.

17. The method of claim 11, wherein, in generating the reference sample signal,
the reference sample signal is generated by applying filtering after reconstructing a sample of the reference unit.

18. The method of claim 17, wherein the filtering is performed based on a ratio between a size of an image of the reference layer and a size of an image of the enhancement layer, and
the filtered reconstructed sample is scaled in accordance with a ratio between a size of an image of the reference layer and a size of an image of the enhancement layer.

19. The method of claim 11, wherein, in generating the reference sample signal,
the reference sample signal is generated by applying offset after reconstructing a sample of the reference unit.

20. The method of claim 19, wherein the offset is applied based on a ratio between a size of an image of the reference layer and a size of an image of the enhancement layer, and
the reconstructed sample to which the offset is applied is scaled in accordance with a ratio between a size of an image of the reference layer and a size of an image of the enhancement layer.
